(19) United States
(12) Patent Application Publication
(10) Pub. No.: US 2012/0210038 A1
(43) Pub. Date: Aug. 16, 2012

(54) EXTERNAL BRIDGE SYSTEM

(75) Inventors: Yung-Hua Liu, Hsinchu City (TW); Chih-Cheng Tu, Hsinchu City (TW); Chia Chen Chang, Hsinchu City (TW); Fu-Chen Cheng, Hsinchu City (TW); Sung-San Chang, Hsinchu City (TW)

(73) Assignee: SKYMEDI CORPORATION, Hsinchu City (TW)

(21) Appl. No.: 13/029,030

(22) Filed: Feb. 16, 2011

(51) Int. Cl. G06F 13/36

(52) U.S. Cl. 710/315

(57) ABSTRACT

An external bridge system includes a host interface, a first device interface and a second device interface, which uses a communication protocol different from that of the first device interface. A bridge controller translates signals compliant with the communication protocol of a host to or from signals compliant with the communication protocol of the first or second device.

### BACKGROUND OF THE INVENTION

1. Field of the Invention

The present invention generally relates to a bridge system, and more particularly to an external bridge system that supports mass storage and card reading.

2. Description of Related Art

A bridge is an electronic system that links a host and a device by converting signals from one communication protocol to another communication protocol. The circuitry and software resided in the bridge should be specifically designed according to the specification of the connected device such as a mass storage device. As the mass storage device, for example, a hard disk drive, is commonly fixed to the host, such as a personal computer, the mass storage device thus lacks versatility in functions and applications.

A card reader is commonly used to accommodate a memory card, which has a storage capacity being generally smaller than that of the mass storage device. The card reader, typically having Universal Serial Bus (USB) interface, is commonly a removable device that is capable of being plugged into or removed from the host.

However, either the mass storage device or the card reader is individually made. As a result, they are limited in functions and applications respectively. A need has therefore arisen to propose a novel scheme that advances the use of the mass storage device and the card reader to acquire more utilization and make more functions from them.

### SUMMARY OF THE INVENTION

In view of the foregoing, it is an object of the embodiment of the present invention to provide an external bridge system that is capable of providing interfacing among a host and a number of devices of different communication protocols. Another object of the embodiment is to operate a memory card in conjunction with a mass storage device via the external bridge system.

According to one embodiment, an external bridge system includes a host interface, a first device interface, a second device interface, and a bridge controller. The host interface is configured to comply with a communication protocol used by a host. The first device interface is configured to comply with a communication protocol used by a first device. The second device interface is configured to comply with a communication protocol used by a second device, the communication protocol of the second device being different from the communication protocol of the first device. The bridge controller is electrically coupled among the host interface, the first device interface, and the second device interface. The bridge controller is configured to translate signals compliant with the communication protocol of the host to or from signals compliant with the communication protocol of the first or second device.

### BRIEF DESCRIPTION OF THE DRAWINGS

FIG. 1 shows a block diagram illustrative of an external bridge system according to one embodiment of the present invention;

FIG. 2 shows a detailed block diagram of the bridge controller of FIG. 1;

FIG. 3A shows a block diagram illustrative of an external bridge system according to a preferred embodiment of the present invention; and

FIG. 3B shows a block diagram illustrative of an external bridge system according to another preferred embodiment of the present invention.

### DETAILED DESCRIPTION OF THE INVENTION

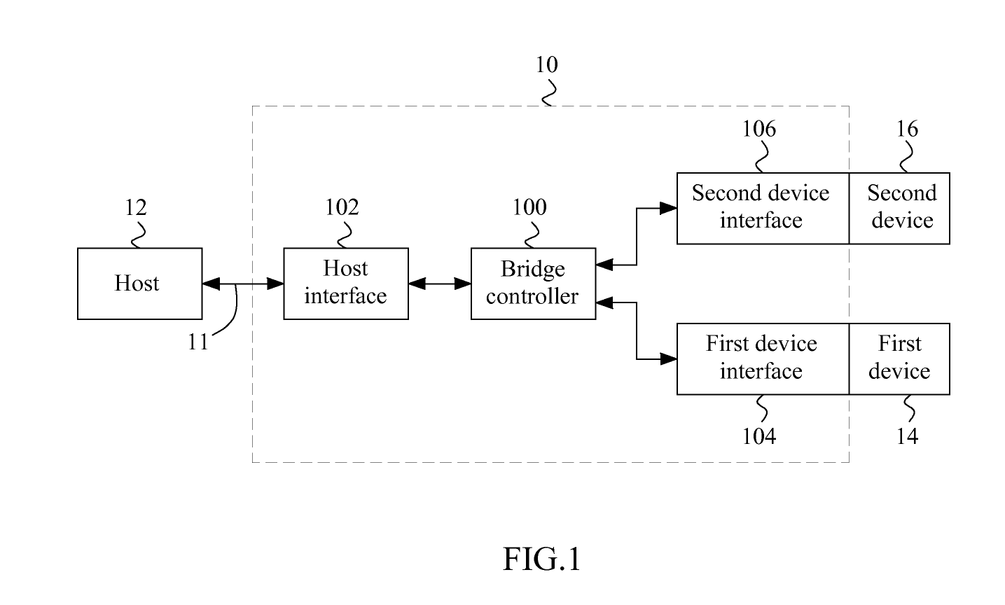

FIG. 1 shows a block diagram illustrative of an external bridge system 10 according to one embodiment of the present invention. The external bridge system 10 may be configured to facilitate the communication among a host 12 and a number of devices, e.g., a first device 14 and a second device 16. The first/second device 14/16 may be enclosed within the external bridge system 10, for example, by a chassis, or may be external to the chassis. The external bridge system 10 may be communicated to the host 12 via a link 11, which may be a wire communication cable or a wireless communication path.

In the embodiment, the external bridge system 10 primarily includes a bridge controller 100, a host interface 102 and a number of device interfaces, e.g., a first device interface 104 and a second device interface 106. Specifically, the host interface 102 communicates with the host 12 via the link 11, and complies with a communication protocol used by the host 12. The first device interface 104 complies with a communication protocol used by the first device 14, and the second device interface 106 complies with a communication protocol used by the second device 16. It is noted that the communication protocol used by the first device 14 is different from the communication protocol used by the second device 16. Moreover, either the first device interface 104 or the second device interface 106 may include a single port that is capable of accommodating one device or include multiple ports that are capable of accommodating a number of devices of the same protocols. The bridge controller 100 is electrically coupled among the host interface 102, the first device interface 104 and the second device interface 106 in order to translate signals compliant with one protocol into signals compliant with another protocol.

The host 12 may be, but is not limited to, a computer (such as a notebook personal computer (PC), a netbook PC, an industry PC), a cellular phone, a smartbook or a smart television (TV) set. The host interface 102 may be, but is not necessarily, a hot-swapping interface such that the external bridge system 10, with or without the first/second device 14/16, may be plugged into or removed from the host 12 without shutting down or significant interruption to the host 12. Some of available, but not exclusive, communication protocols for the host interface 102 are Universal Serial Bus (USB), IEEE 1394, Serial Advanced Technology Attachment (SATA), external SATA (eSATA), micro SATA, Bluetooth and WiFi.

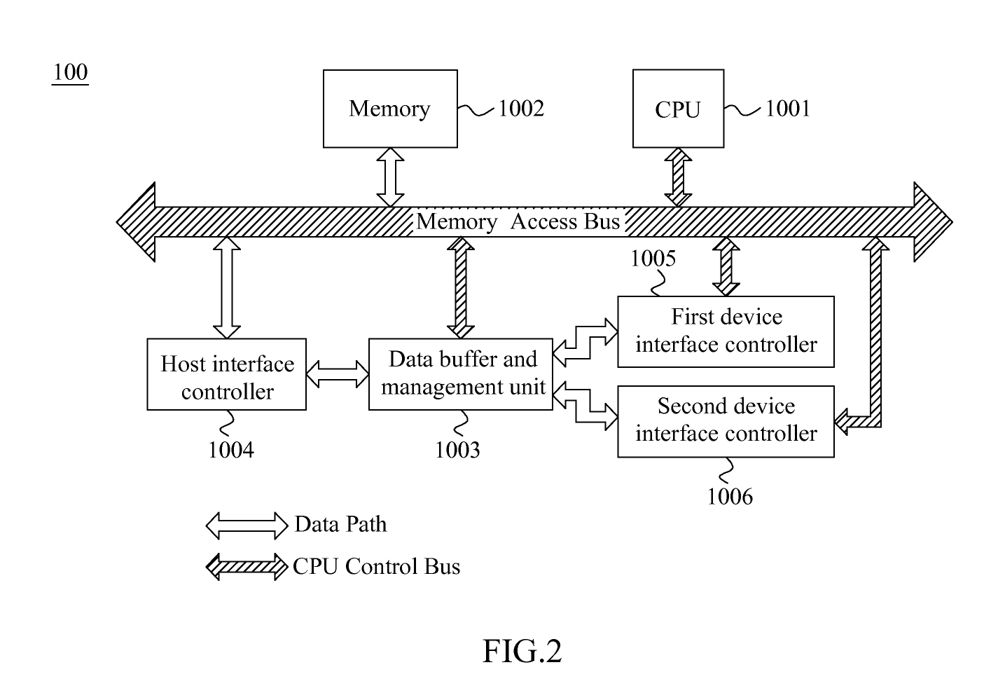

FIG. 2 shows a detailed block diagram of the bridge controller 100 of FIG. 1. In the embodiment, the bridge controller 100 includes a central processing unit (CPU) 1001, a memory 1002, a data buffer and management unit 1003, a host interface controller 1004, a first device interface controller 1005 and a second device interface controller 1006. The CPU 1001 takes control of the bridge controller 100 by executing programs stored in the memory 1002. The data buffer and management unit 1003 temporarily stores and manages data transferred from the host 12 to the first/second device 14/16 or data transferred from the first/second device 14/16 to the host 12. The host interface controller 1004 communicates with the host interface 102, which further communicates with the host 12. The first device interface controller 1005 communicates with the first device interface 104, which further communicates with the first device 14. The second device interface controller 1006 communicates with the second device interface 106, which further communicates with the second device 16.

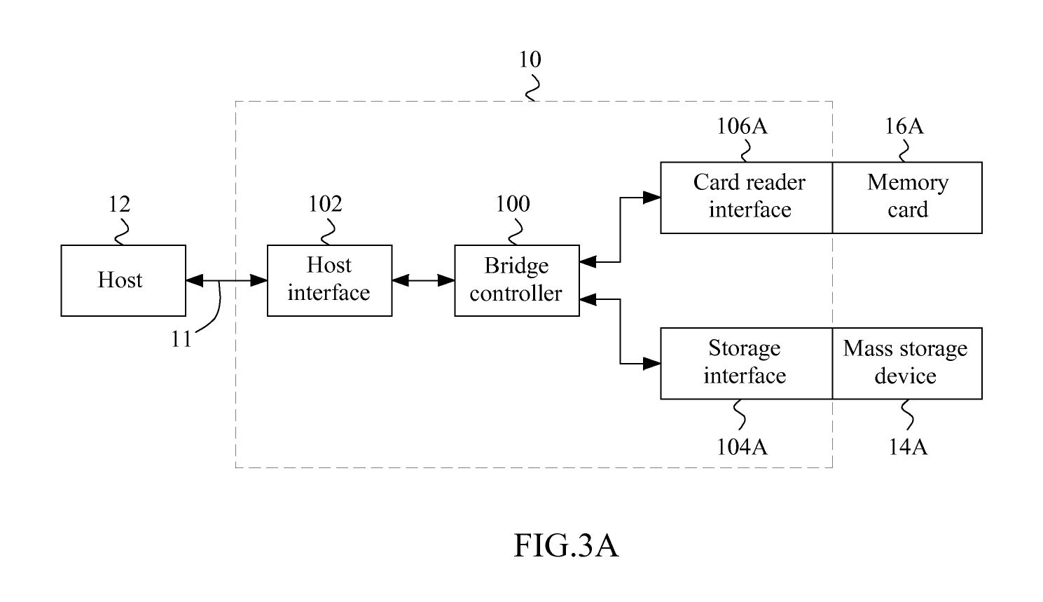

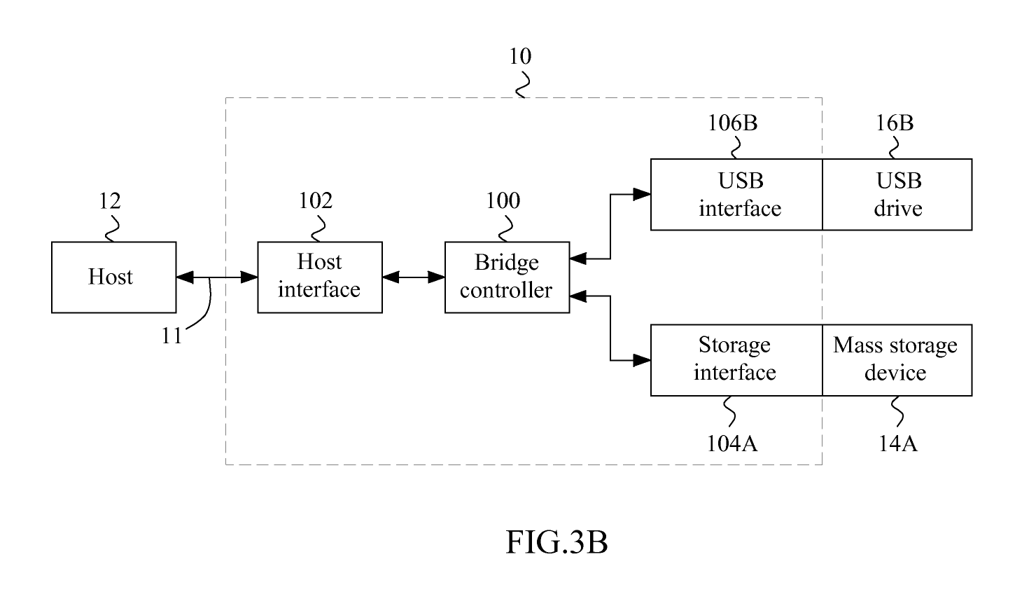

FIG. 3A shows a block diagram illustrative of an external bridge system 10 according to a preferred embodiment of the present invention. In this preferred embodiment, the first device interface 104 (FIG. 1) is a storage interface 104A adaptable to a mass storage device 14A, such as, but is not limited to, a hard disk drive (HDD), a solid-state drive (SSD), a hybrid disk drive, an optical disk drive (ODD), a magneto-optical (MO) drive, a flash disk or a phase change disk. The storage interface 104A is preferably a fixed or irremovable interface by which the mass storage device 14A is firmly attached to the external bridge system 10 with or without a connector. Some of available, but not exclusive, communication protocols for the storage interface 104A are Integrated Drive Electronics (IDE), Serial Advanced Technology Attachment (SATA), Small Computer System Interface (SCSI), Flash and ZIP. In the preferred embodiment, the second device interface 106 is a card reader interface 106A adaptable to a memory card 16A, such as, but is not limited to, a secure digital (SD) card, a mini SD card, a smart card, a multimedia card (MMC) or an embedded MMC (e-MMC). The card reader interface 106A is preferably a hot-swapping interface by which the memory card 16A may be plugged into or removed from the external bridge system 10 without shutting down or significant interruption to the external bridge system 10. In an alternative embodiment, the card reader interface 106A is firmly attached to the external bridge system 10 without a connector.

FIG. 3B shows a block diagram illustrative of an external bridge system 10 according to another preferred embodiment of the present invention. The embodiment of FIG. 3B is similar to the embodiment of FIG. 3A with the exception that the second device interface 106 is a USB interface 106B adaptable to a USB drive 16B.

According to the preferred embodiment as shown in FIG. 3A or 3B, in one specific preferred embodiment, the memory card 16A or the USB drive 16B may be configured as an AutoRun component which acts when the external bridge system 10 powers on or is accessed. After activating the AutoRun component, content of the memory card 16A or the USB drive 16B may be run automatically. Some available, but not exclusive, content may be optimization software that improves execution speed or efficiency, product description or advertisement, an audio/video clip or an attached program such as game.

In another specific preferred embodiment, the memory card 16A or the USB drive 16B may be emulated to act, for example, a cache or an optical disk drive. The emulation of the optical disk drive, for example, may be accomplished by acknowledging a connection request sent from the host 12 with signals compliant with the communication protocol of the optical disk drive. One of the advantages of using the memory card 16A or the USB drive 16B as an emulated device is substituting a small-volume memory card 16A or the USB drive 16B for a bulky optical disk drive and its optical disk.

In a further specific preferred embodiment, the memory card 16A or the USB drive 16B may be operative in conjunction with the mass storage device 14A. In the embodiment, the memory card 16A or the USB drive 16B may be used to provide access rights to the mass storage device 14A. For example, some or all region, including a protected region, of the mass storage device 14A can be accessed when the memory card 16A is electrically coupled to the card reader interface 106A (e.g., the memory card 16A is inserted in a card reader associated with the card reader interface 106A) or the USB drive 16B is electrically coupled to the USB interface 106B; otherwise, only a public region of the mass storage device 14A can be accessed.

Although specific embodiments have been illustrated and described, it will be appreciated by those skilled in the art that various modifications may be made without departing from the scope of the present invention, which is intended to be limited solely by the appended claims.

What is claimed is:

1. An external bridge system, comprising:
a host interface configured to comply with a communication protocol used by a host;
a first device interface configured to comply with a communication protocol used by a first device;
a second device interface configured to comply with a communication protocol used by a second device, the communication protocol of the second device being different from the communication protocol of the first device; and
a bridge controller electrically coupled among the host interface, the first device interface and the second device interface, the bridge controller being configured to translate signals compliant with the communication protocol of the host to or from signals compliant with the communication protocol of the first or second device.

2. The external bridge system of claim 1, further comprising a link through which the host interface communicates with the host.

3. The external bridge system of claim 1, wherein the first or second device interface includes a single port that is capable of accommodating one device or multiple ports that are capable of accommodating a plurality of devices of the same communication protocols.

4. The external bridge system of claim 1, wherein the host is a computer, a cellular phone, a smartbook or a smart TV set.

5. The external bridge system of claim 1, wherein the host interface is a hot-swapping interface.

6. The external bridge system of claim 1, wherein the communication protocol of the host interface is USB, IEEE 1394, SATA, eSATA, micro SATA, Bluetooth or WiFi.

7. The external bridge system of claim 1, wherein the bridge controller comprises:
a memory configured to stored a program;
a central processing unit configured to take control of the bridge controller by executing the program stored in the memory;
a data buffer and management unit configured to temporarily store and manage data transferred from the host to the first or second device or the data transferred from the first or second device to the host;
a host interface controller configured to communicate with the host interface;
a first device interface controller configured to communicate with the first device interface; and
a second device interface controller configured to communicate with the second device interface.

8. The external bridge system of claim 1, wherein the first device interface is a storage interface adaptable to a mass storage device, and the second device interface is a card reader interface adaptable to a memory card or the second device interface is a USB interface adaptable to a USB drive.

9. The external bridge system of claim 8, wherein the storage interface is a fixed interface, and the card reader interface is a hot-swapping interface.

10. The external bridge system of claim 8, wherein the mass storage device is a hard disk drive, a solid-state drive, a hybrid disk drive, an optical disk drive, a magneto-optical drive, a flash disk or a phase change disk.

11. The external bridge system of claim 8, wherein the communication protocol of the storage interface is IDE, SATA, SCSI, Flash or ZIP.

12. The external bridge system of claim 8, wherein the memory card is an SD card, a mini SD card, a smart card, an MMC card or an e-MMC.

13. The external bridge system of claim 8, wherein the memory card or the USB drive is configured as an AutoRun component.

14. The external bridge system of claim 13, wherein content of the AutoRun component is run automatically after the AutoRun component is activated.

15. The external bridge system of claim 14, wherein the content of the AutoRun component is optimization software, product description or advertisement, an audio or video clip, or an attached program.

16. The external bridge system of claim 8, wherein the memory card or the USB drive is emulated to act as an emulated device.

17. The external bridge system of claim 16, wherein the emulated device is a cache or an optical disk drive.

18. The external bridge system of claim 8, wherein the memory card or the USB drive is operative in conjunction with the mass storage device to provide access rights to the mass storage device.

19. The external bridge system of claim 18, wherein the mass storage device includes a protected region and a public region, wherein the protected region is authorized to be accessed when the memory card is electrically coupled to the card reader interface or the USB drive is electrically coupled to the USB interface; otherwise, only the public region of the mass storage device is permitted to be accessed.
